(19) United States
(12) Patent Application Publication
(10) Pub. No.: US 2017/0132583 A1
(43) Pub. Date: May 11, 2017

(54) FASTER CROSS BORDER REMITTANCES USING CROWD SOURCED FUNDING CACHE

(71) Applicant: PAYPAL, INC., San Jose, CA (US)

(72) Inventor: Rahul Nair, San Jose, CA (US)

(21) Appl. No.: 14/935,650

(22) Filed: Nov. 9, 2015

(51) Int. Cl. G06Q 20/02; G06Q 40/02; G06Q 20/10

(52) U.S. Cl. CPC G06Q 20/027; G06Q 20/10; G06Q 40/025

(57) ABSTRACT

Systems and methods for accelerating availability of funds involved in a money transfer from a first user account at a first financial institution to a second user account at a second financial institution. An example method includes receiving a first message from the first financial institution that indicates intent to transfer a monetary amount from the first user account to the second user account. Upon receiving the message, it is determined whether the second user account is associated with a money cache account and if so, transferring at least a portion of the indicated monetary amount from the money cache account to the second user account. At a later time, a second message is received from the first financial institution that includes the monetary amount to be transferred. The second message is processed by transferring at least a portion of the received monetary amount to the money cache account.

### BACKGROUND

1. Field of the Invention

The present disclosure generally relates to electronic transfers between accounts where the transfer is processed and completed over a matter of time and a user does not have access to the transfer prior to transfer completion. [I generalized this a bit to hopefully keep it out of the art units and classes that are less friendly to Alice arguments.]

2. Related Art

Electronic transfers, such as money transfers or wire transfers, between accounts at different financial institutions are currently processed using a predefined network or protocol. One such network is the SWIFT network provided by the Society for Worldwide Interbank Financial Telecommunication in La Hulpe, Belgium. The SWIFT system and network provides a secure means for financial institutions around the world to communicate about and perform money transfers. The financial institutions accessing the SWIFT network are identified by numbers or SWIFT codes. These codes allow financial institutions to identify one another such that they can perform money transfers between their various accounts. In other words, the SWIFT system does not perform money transfers but instead establishes a standard that financial institutions can use to communicate in order to perform transfers.

The problem with wire transfers and particularly international transfers is that it can be a timely process. Users needing access to funds being transferred from another financial institution must therefore wait until the transfer process is complete before obtaining access to the funds. Thus, there is a need for providing users faster access to money that is in the process of being transferred from another financial institution but yet not actually received.

### BRIEF DESCRIPTION OF THE FIGURES

FIG. 1 is a diagram illustrating the process of transferring funds using a money cache as described in the embodiments discussed herein.

FIG. 2A is a diagram illustrating a first example system embodiment for transferring funds between user accounts using a money cache account.

FIG. 2B is a diagram illustrating a second example system embodiment for transferring funds between user accounts using a money cache service.

FIG. 3 is an example method embodiment for transferring funds between user accounts using a money cache account.

FIG. 4 is a diagram illustrating an example computer system for transferring money between user accounts using a money cache account where the components of the system are organized into functional software components.

FIG. 5 illustrates an embodiment of a network-based system for implementing one or more processes described herein.

FIG. 6 is a diagram illustrating an example computer system that can be used to carry out the various features of the embodiments described herein.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes systems and methods for providing a faster way for customers to access funds that are in the process of being transferred, but not yet received from another financial institution.

The embodiments described herein include systems and methods for accelerating the availability of a monetary amount being transferred from a first user account at a first financial institution to a second user account at a second financial institution. An example method includes receiving a first message from the first financial institution. The first message indicates intent to transfer a monetary amount from the first user account to the second user account. Upon receiving the message, it is determined whether the second user account is associated with a money or funding cache account. When the second user account is associated with the money cache account, at least a portion of the monetary amount indicated in the first message is transferred from the money cache account to the second user account. At a later time, a second message is received from the first financial institution that includes at least the monetary amount to be transferred. The second message is processed by transferring at least a portion of the monetary amount included in the second message to the money cache account.

In the following detailed description, references to “one embodiment,” “an embodiment,” “an example embodiment,” etc., indicate that the embodiment described may include a particular feature, structure, or characteristic. Every embodiment, however, may not necessarily include the particular feature, structure, or characteristic. Thus, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following detailed description refers to the accompanying drawings that illustrate example embodiments. Other embodiments are possible, and modifications can be made to the embodiments within the spirit and scope of this description. Those skilled in the art with access to the teachings provided herein will recognize additional modifications, applications, and embodiments within the scope thereof and additional fields in which embodiments would be of significant utility. Therefore, the detailed description is not meant to limit the embodiments described below.

The embodiments and accompanying figures described below generally relate to wire transfers between financial institutions and providing users faster access to the funds being transferred. In one embodiment, a financial institution offers a money cache service where funds that are in the process of being transferred are made available to a user through the money cache service before the fund transfer is complete. In another embodiment, the money cache service is offered by a third party which charges a fee that is collected from the incoming transfer for using the service. These embodiments are illustrated in reference to the accompanying figures as follows.

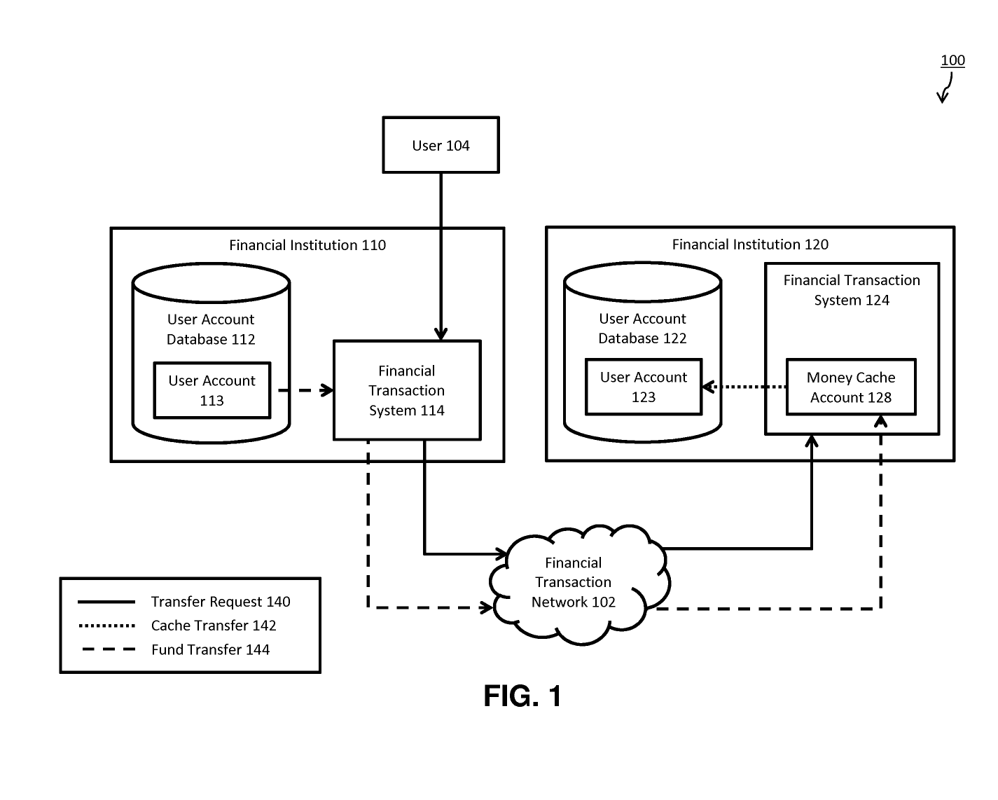

FIG. 1 is a diagram illustrating a process flow 100 for transferring funds using a money cache. Process flow 100 shows the process for transferring funds from a user account 113 at a financial institution 110 to a user account 123 at a financial institution 120 using a money cache account 128 to speed the process of user account 123 having access to the funds. For example, when a user such as user a 104 desires to transfer funds from an account such as, for example, user account 113 to a user account housed at another financial institution such as user account 123, the process for transferring the funds may be a timely process. To speed fund availability, the receiving financial institution may utilize the embodiments described herein of using a money cache to temporarily make the funds available to user account 123 before the funds are actually received by the financial institution.

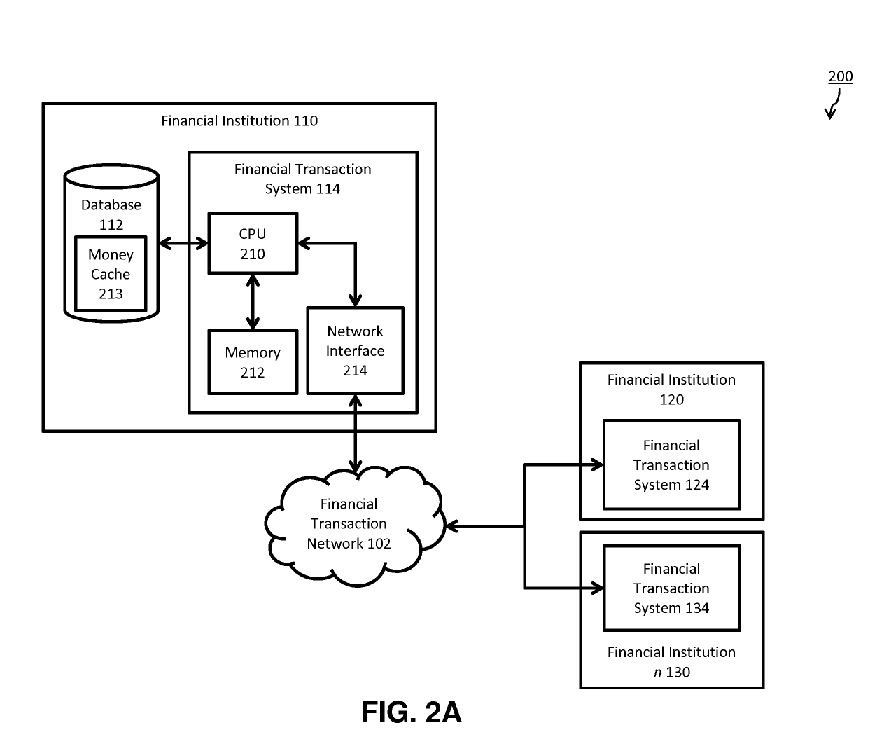

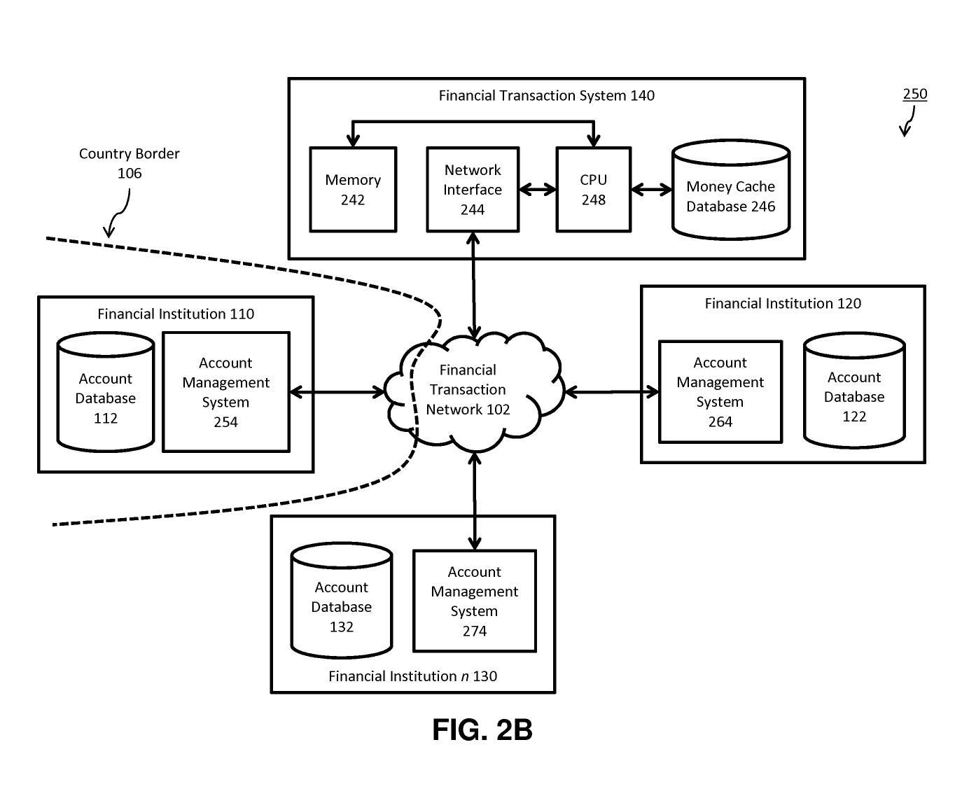

In FIG. 1, as discussed briefly above, user 104 is the owner of user account 113 housed at financial institution 110. User account 113 is stored in a user account database 112 with other user accounts managed by financial institution 110. In some embodiments, the user accounts are stored in database 112 and are managed by financial institution 110 though financial transaction system 114. Financial transaction system 114 may be implemented using a computer system such as, for example, a client-server computer system. In such a configuration, financial transaction system 114 may be connected to a number of clients using a closed or open network configuration. Financial transaction system 114 may also be configured such that users can access and utilize account management features via a network such as the Internet. Financial transaction system 114 is discussed in more detail in reference to FIGS. 2A-B and 3.

Financial transaction system 114 utilizes a network such as a financial transaction network 102 to connect financial institution 110 to other financial institutions such as, for example, financial institution 120. The financial transaction network 102 may be implemented as a single network or a combination of multiple networks. For example, in various embodiments, the network 102 may include a closed, private communication network or an open network such as the Internet. Network 102 may be made up of one or more intranets, landline networks, wireless networks, cellular networks, satellite networks, and/or other appropriate types of networks. In some examples, the financial institutions 110 and 120 may communicate through the network 102 via cellular communication, wireless communication (e.g., via a WiFi network), or any of a plurality of other radio and/or telecommunications protocols by way of one or more financial transaction systems 114 and 124. In addition, financial institutions 110 and 120 may communicate through the network 102 using any one of a number of secure communication, encryption, or private messaging protocols.

Like financial institution 110, financial institution 120 includes a financial transaction system 124 that connects financial institution 120 to other financial institutions via network 102. Financial institution 120 also includes a user account database 122 that stores accounts such as user account 123. Financial institution 120 may also utilize a money cache account 128 that can be used to speed up fund availability so that funds that are in the process of being transferred can be made available before the funds are actually received. The money cache account 128 can be managed by financial transaction system 124 and can be stored with other user accounts in database 122, but may also be stored directly in memory or another storage means at financial institution 120. Money cache account 128 may be funded by the financial institution for the benefit of its customers or may be funded by customers that wish to participate. Also, money cache account 128 may not be a separate account but may be a designator placed on funds in a user's account that the user wishes to set aside for use as a money cache.

An example of the process of utilizing money cache account 128 to speed the fund availability to user account 123 may be as follows. User 104 may desire to transfer funds from user account 113 at financial institution 110 to user account 123 at financial institution 120. To initiate the transfer, user 104 may use a number of options such as, for example, speak to a teller at financial institution 110 or access account management features of financial transaction system 114 via a computing device. Once user 104 initiates the transfer, financial transaction system 114 may send a transfer request 140 to the receiving financial institution—in this case financial institution 120. Transfer request 140 may be a message formatted according to a particular standard or may utilize an existing financial messaging framework such as, for example, SWIFT, EFT, or another similar messaging protocol.

Upon receiving transfer request 140, financial transaction system 124 will determine whether the user account 123, which is indicated in transfer request 140, is able to use money cache account 128. Financial transaction system 124 may use a number of considerations for determining whether user account 123 has access to money cache account 128. These considerations may include, for example, previous usage history, the funds currently available in user account 123, whether user account 123 has participated in funding the money cache account, or a trust relationship between the user associated with user account 123 and financial institution 120. For example, if a user contributes an amount to a money cache account, the user's ability to receive funds from the money cache account may be limited to the contributed amount or a portion of the contributed amount. These factors and others may be used to compile a score that can be used to more easily determine whether a user account can utilize a money cache account.

A user may also designate a preference to participate in the money cache account and a manner of participation. The preference may consider, for example, the amount of the transfer, how frequently transfers between the user accounts indicated in the transfer request occur, or whether the transferring account is known to the receiving account. For instance, a user may set a preference to only use a money cache account for only a portion of an incoming transfer. The preference may set the amount in terms of a percentage or a fixed amount. Additionally, a user may set a preference to use a money cache account only for transfers incoming from certain sources or only for transfers that occur at a regular interval.

If financial transaction system 124 determines that user account 123 has access to the money cache account, at least a portion of the funds indicated in transfer request 140 are transferred from money cache account 128 to user account 123. This transfer is indicated in FIG. 1 by cache transfer 142. Because fund transfers between financial institutions can be a timely process, money cache account 128 makes it possible for funds that will be transferred to be available to user account 123 before the actual fund transfer completes.

At some point after transfer request 140 has been made to financial institution 120, a second message indicated by fund transfer 144 may be transmitted from financial transaction system 114 to financial transaction system 124. Fund transfer 144 may similarly be a message formatted in a particular format or may utilize an existing financial messaging framework such as, for example, SWIFT, EFT, or another similar messaging protocol. The purpose of fund transfer 144 is to actually transfer funds from user account 113, as requested by user 104, to user account 123. Upon receiving fund transfer 144, financial transaction system 124 will first determine whether the funds associated with this transfer were already made available to user account 123 by money cache account 128. If money cache account 128 previously provided at least a portion of the funds to user account 123, the portion provided will be transferred to money cache account 128 with the remainder transferred to user account 123.

In some embodiments, a fee may be withheld from the funds transferred to user account 123. The withheld funds may be used to fund money cache account 128 or paid to financial institution 120 for providing the money cache service. The fee may be different depending on a number of factors. For example, if a user associated with user account 123 contributes to money cache account 128, the fee may be lower than for a user that does not. In other words, if the fee is a percentage of the amount transferred from the money cache account, a contributing user may be charged a lower rate than a noncontributing customer. The fee may be retained by the financial institution but may also be paid out to the contributors of the money cache account. If paid out, each contributor may be paid proportionally to the amount contributed, or payment may be based on a usage frequency where less frequent users are paid more than frequent users.

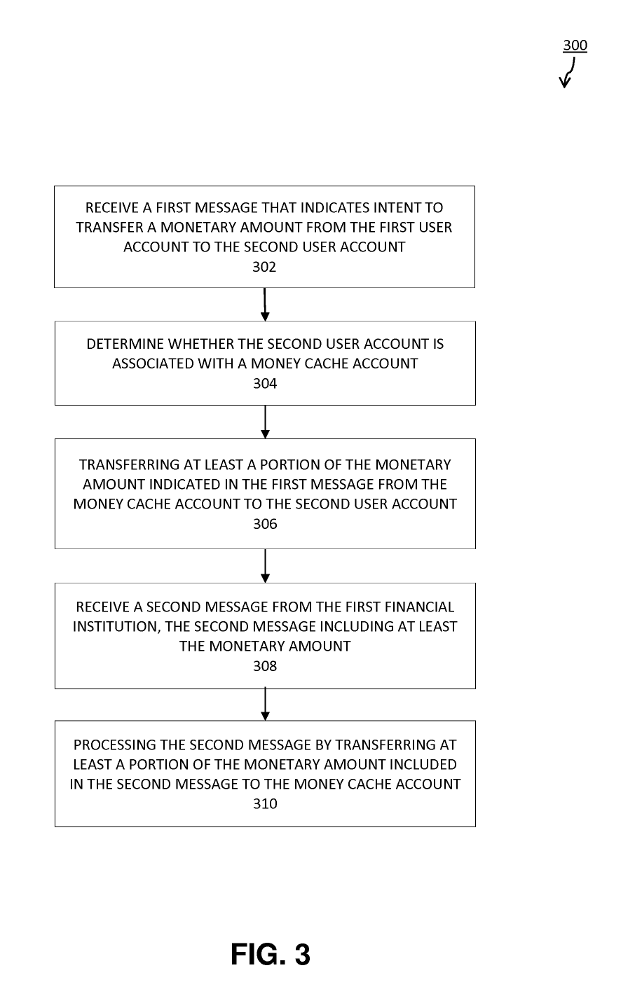

FIG. 2A is a diagram illustrating an example system 200 for transferring funds between user accounts using a money cache account. Similar to the diagram in FIG. 1, system 200 includes financial institution 110 that uses a financial transaction system 114 to manage user accounts stored in database 112. In addition to storing user accounts, database 112 may also store one or more money cache accounts represented as a money cache account 213. Financial transaction system 114 can be a computer system known in the art but modified to utilize the features of a money cache account. In particular, each financial institution in system 200 may utilize one or more money cache accounts for speeding the availability of funds transferred between user accounts at different financial institutions. For example, financial transaction system 114 includes a CPU 210, a memory 212, and a network interface 214. CPU 210, memory 212, and network interface 214 allow financial transaction system 114 to store data, execute instructions, communicate with other computer systems, and manage user accounts. These components are enhanced in the embodiments described herein by, for example, the software embodiment illustrated in FIG. 3 that includes providing user accounts the features of a money cache account service.

System 200 also includes financial institutions 120 and 130 that utilize respective financial transaction systems 124 and 134 to manage user accounts in one or more databases located at their respective financial institutions. These databases may be similar to database 112 and may also include one or more money cache accounts. A person of ordinary skill in the art will understand that financial transaction systems 124 and 134 may be configured similar to financial transaction system 114 or modified to meet the particular needs of each respective financial institution. Additionally, database 112 may be shared between multiple financial institutions or a single financial institution may have multiple databases 112. A person of ordinary skill in the art will also understand that financial institutions 110, 120, and 130 may communicate via a network such as financial transaction network 102, described above.

Financial institutions 110, 120, and 130 are represented by example since they are only a portion of the financial institutions that may be connected via financial transaction network 102. In fact, system 200 may support any number of financial institutions in various locations. For example, financial institutions 110, 120, and 130 may each be located in a different country. In this case, the features of the money cache account may be particularly useful since processing international money transfers may take more time and providing user accounts faster access to incoming funds may be more desirable. Additionally, while system 200 shows each financial institution having a financial transaction system, financial institutions in the same country, union, treaty organization, etc., for example, may share one or more financial transaction systems and money cache accounts. An example of this embodiment is represented in FIG. 2B.

FIG. 2B is a diagram illustrating an example system 250 for transferring funds between user accounts using a money cache account. System 250 differs from system 200 in that the financial transaction system 140 is not located at a particular financial institution, but is shared among financial institutions in the same country such as, for example, financial institutions 120 and 130. In this example, each respective financial institution utilizes an account management system 254, 264, and 274. Account management systems 254, 264, and 274 may be conventional account management systems used by financial institutions. These account management systems, though, may be enhanced to utilize the money cache service provided by financial transaction system 140. For example, a request to transfer funds may originate at financial institution 110. This request may require a transfer of funds from a user account at financial institution 110 to a user account at financial institution 120. As described above in reference to FIG. 1, a first message may be transmitted from financial institution 110 to financial institution 120 indicating that a fund transfer is in progress. The first message may indicate the account at financial institution 110 that is sending the funds, the account at financial institution 120 that is receiving the funds, currency information, the amount to be transferred, and other relevant data necessary to initiate the transfer.

Upon receiving the first message, financial institution 120 may analyze the request to determine the transfer amount and the receiving account. Financial institution 120 may also determine whether the receiving account has access to pull funds from a money cache service provided by, for example, financial transaction system 140. This determination may be accomplished by providing financial transaction system 140 with information identifying the receiving account or the user associated with the receiving account. Financial transaction system 140 may then determine if the user or receiving account has sufficient access to use the money cache service. If the receiving account does in fact have sufficient access to use the money cache service, at least a portion of the funds indicated in the first message may be transferred from one or more accounts stored in money cache database 246 to the receiving account at financial institution 120. Because financial transaction system 140 and financial institution 120 are in the same country—indicated by a country border 106—the fund transfer from the money cache service to the receiving account may use an existing domestic fund transfer service. Since domestic transfers are usually completed in less time than international transfers, the receiving account will have quicker access to funds that are being transferred from another country.

At some point after the funds are provided to the receiving account from the money cache service, funds are transmitted from the user account at financial institution 110 to financial institution 120 via a second message. The second message may include, for example, the user account at financial institution 110 that is sending the funds, the receiving account at financial institution 120 that is receiving the funds, currency information, and the funds indicated by an amount or other necessary data. Upon receiving the second message, financial institution 120 will check whether the first message resulted in a transfer from the money cache service to the receiving account. In this example, since the receiving account did in fact use the money cache service, financial institution 120 will route funds received in the second message to the money cache service in the amount previously provided to the receiving account. In addition, the money cache service may receive an additional amount from the received funds as a fee for providing the money cache service.

In some embodiments, access to use the money cache service may be determined by a number of factors. For example, access may be determined by a score assigned to the receiving account or the user associated with the receiving account. The score may be based on, for example, whether a user has previously utilized the money cache service or whether previous usage of the money cache service resulted funds being transferred back to the money cache service upon the user account receiving the actual funds. Moreover, in some embodiments, the money cache service may be funded by fellow users and the score may be based on how much a particular user contributed to funding the money cache service. The score may also be based on the number times a particular user has utilized the money cache service, a usage fee amount, a level of service contracted for, the amount currently desired or previously provided from the money cache service, or a user's credit score or other financial scoring system.

FIG. 3 illustrates example embodiment method 300 for transferring funds between user accounts using a money cache account. One of ordinary skill in the art in possession of the present disclosure will recognize that the method 300 may be performed for a plurality of different financial institutions at variety of physical locations. It will also be understood that additional steps may be performed before, during, and/or after the steps described below with reference to the method 300. Additionally, method 300 is only provided as an example and is not intended to limit the embodiments described herein.

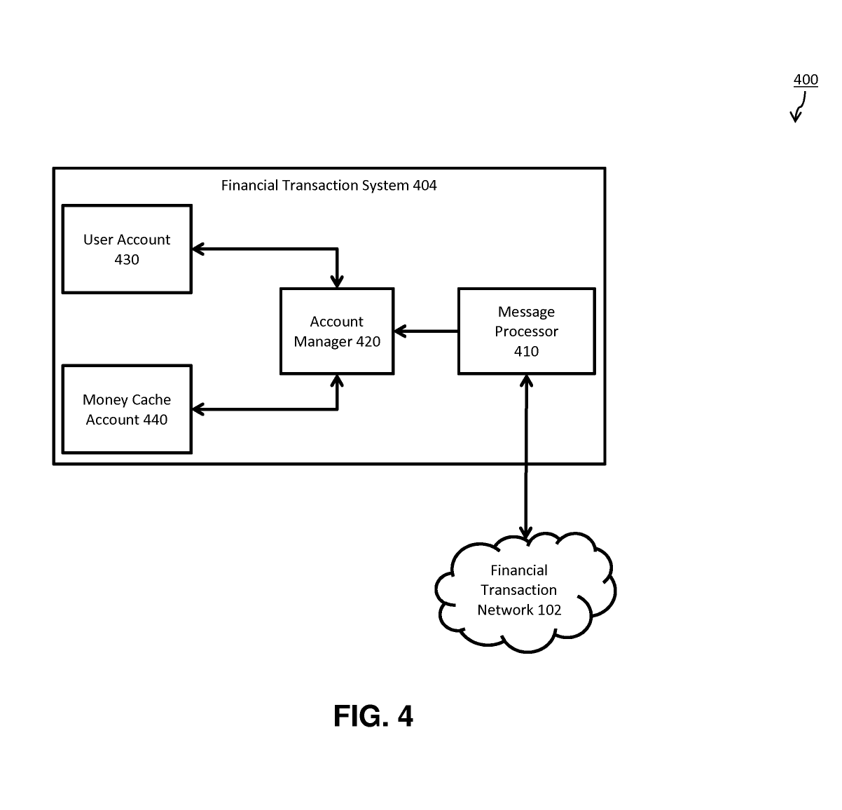

Method 300 begins at block 302 by receiving a first message from a first financial institution. The first message indicates intent to transfer a monetary amount or funds from a first user account at the first financial institution to a second user account at a second financial institution. As discussed herein, the first message may be in a predefined format for the purposes of standardizing communications between financial institutions. The first message may be organized into a data structure with data fields that include the amount to be transferred, information about the sending account and financial institution, and information about the receiving account and financial institution. The first message may also be encrypted or otherwise protected according to a security protocol to protect and provide privacy to communications between financial institutions. Block 302 may be carried out by, for example, message processor 410 in FIG. 4, discussed below.

Method 300 then proceeds to block 304 by determining whether the second user account is associated with a money cache account. The association with a money cache account can be determined based on a score associated with the second user account or the user associated with the second user account. As discussed, the score can be based on a number of factors including, for example, money cache account usage, credit history, user history with the second financial institution, or other factors that establish a trust relationship between a user and financial institution. The association with a money cache account may also be determined based on a user preference, a fee structure, or a prearranged contract to use such services. Block 304 may be carried out by, for example, account manager 420 in FIG. 4, discussed below.

If the second user account is in fact able to access a money cache account or service, method 300 proceeds to block 306 by transferring at least a portion of the monetary amount indicated in the first message from the money cache account to the second user account. In some embodiments, using the money cache service may require a fee or contribution to the account for its ongoing maintenance. In these cases, a portion less than the monetary amount indicated in the first message may be withheld for the fee or contribution. Moreover, the amount transferred from the money cache account to the second user account may be decreased based on the score such that only a fixed amount or percentage is transferred.

Because the embodiments contemplate transferring funds across international borders, the amount transferred from the money cache account to the second user account may also take into account currency exchange rates and international banking practices. Block 306 may be carried out by, for example, account manager 420 in FIG. 4, discussed below.

Method 300 then proceeds to block 308 by receiving a second message from the first financial institution Like the first message, the second message may be in a predefined format and encrypted or otherwise secured. The second message may comprise a data structure that includes at least the monetary amount but may also include information about the sending account and financial institution, the receiving account and financial institution, an identifier linking it to the first message, or other information necessary to complete the transfer. Block 308 may be carried out by, for example, message processor 410 in FIG. 4, discussed below.

Method 300 then proceeds to block 310 by processing the second message. The second message is processed by transferring at least a portion of the monetary amount included in the second message to the money cache account. As discussed in relation to block 306, this portion may be the entire amount or an amount necessary to replenish the money cache account and pay any fees or contributions. Block 310 may be carried out by, for example, account manager 420 in FIG. 4, discussed below.

While not shown in FIG. 4, additional blocks may be added to the method such as adjusting the score associated with the user or user account based on whether the money cache account is replenished, or the time is takes to actually complete the transfer. Additional blocks may also include performing currency conversions or determining a money cache service to use from a plurality of available money cache service providers. Moreover, while method 300 is shown as being performed in relation to system 400, method 300 may be completed in diverse ways and not all of the blocks need be performed by the same system or at the same location. For example, the money cache account may be a third-party money cache service that financial institutions interact with via network 102.

Thus, systems and methods have been described that provide speeding the availability of funds when money transfers between financial institutions are in progress. The embodiments described herein provide customers with a reliable way to access funds when desired instead of having to wait for a timely transfer process to complete. It is additionally noted that the embodiments described herein describe technological solutions to problems associated with the handling of currency or other monetary instruments (e.g., with respect to e-commerce, electronic currency, and electronic banking) that did not exist prior to the advent of computer networks and the Internet.

Various examples of technological devices and systems that may be used to implement embodiments of the present disclosure are discussed in more detail below with reference to FIG. 4-6.

FIG. 4 illustrates system 400 which is an example software embodiment executing on a financial transaction system discussed above in reference to FIGS. 1 and 2A-B. System 400 includes a financial transaction system 404 with several software modules that are executed by a computer processor for the purpose of carrying out the features of a money cache service. Financial transaction server 404 includes a message processor 410, an account manager 420, a user account 430, and a money cache account 440.

Message processor 410 is coupled to financial transaction network 102 and is configured to receive a first message and a second message. The messages can be received from network 102 through a network interface such as, for example, network interface 214. As discussed above, the first message indicates intent to transfer a monetary amount to user account 430 and the second message includes at least the monetary amount or funds that are intended to be transferred into the user account.

Upon message processor 410 receiving the first message, processing of the message is passed to account manager 420. Account manager 420 is configured to analyze the message to determine if it is a notification that funds are to be transferred to a user account. Account manager 420 may then elect to process the message by transferring at least a portion of the monetary amount or funds indicated in the first message from a money cache account, such as money cache account 440, to the designated user account such as user account 430.

Money cache account 440 and user account 430 are merely provided as examples and are not intended to limit them embodiments described herein. Accordingly, account manager 420 may be configured to manage multiple user accounts and money cache accounts stored locally or at remote systems.

Account manager 420 is also configured to process the second message as it is received by message processor 410. To process the second message, account manager 420 analyzes the message to determine if it is in fact a transfer of funds from another institution to a user account managed by account manager 420. Account manager 420 may then determine whether the first message was received and whether processing of the first message resulted in any funds being transferred from the money cache account to the user account. If account manager 420 determines that such a transfer occurred, account manager 420 will first transfer the funds to the money cache account and then transfer any remaining funds to the designated user account.

In some embodiments, as discussed above, the amount transferred from the money cache account to the user account may be less than the amount indicated in the first message.

For example, account manager 420 may require a fee to be paid to use the money cache account. In this case, when processing the first message, account manager 420 may transfer less than the amount indicated in the first message from the money cache account to the user account. Then, when processing the second message, account manager 420 may transfer the entire amount included in the second message to the money cache account. In another example, the amount transferred from the money cache account to the user account may be limited to fixed amount or a percentage of the amount indicated in the first message. In this case, the second message is processed by account manager 420 determining the amount transferred from the money cache account, replacing that amount with the funds included in the second message, and transferring any remainder, minus any fees, into the user account.

The software embodiment in FIG. 4 may be provided as an infrastructure (e.g., a set of APIs and UI interface) to financial institutions so that financial institutions may leave implementation of the money cache management system to the software platform, thus removing the need to develop these capabilities in-house. This means that a financial institution may simply carve out a money cache account and provide the details of the account to the software embodiment as part of initialization. Once this is done, for money transfers received by a financial institution, the software embodiment would then process money cache service requests, when the user account is eligible. The software embodiment may provide services to financial institutions so that account holders may be able to pool money periodically or one-time in the money cache. Alternatively, the financial institution may choose to build these capabilities on its own and manage the money cache account in-house.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

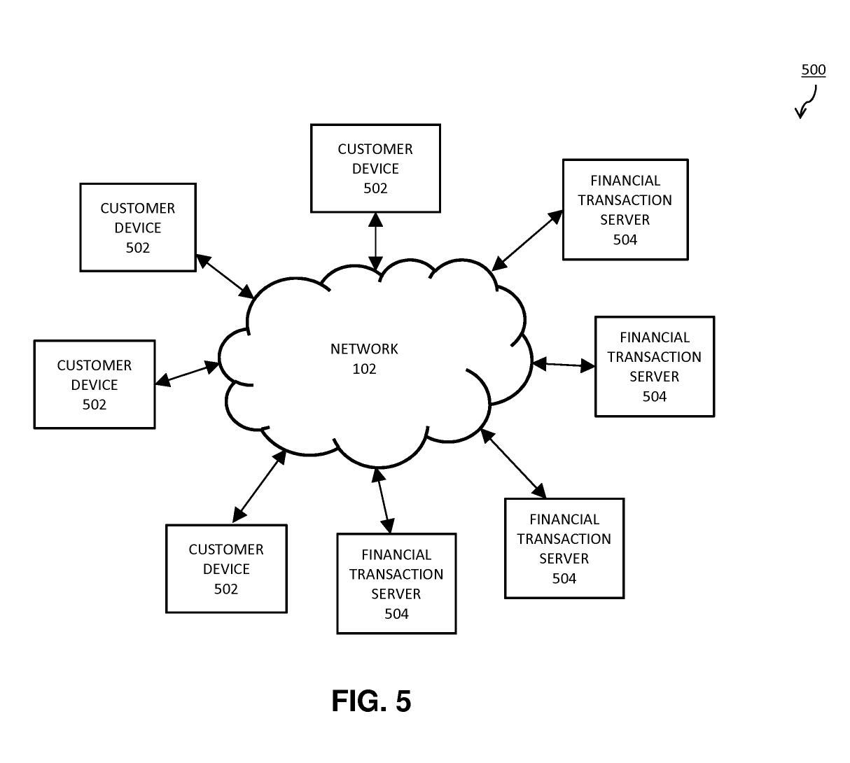

FIG. 5 illustrates an embodiment of a network-based system 500 for implementing one or more processes described herein. The network-based system 500 may comprise a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It should be appreciated that the servers illustrated in FIG. 5 may be deployed in other ways and that the operations performed and/or the services provided by such servers may be combined or separated for a given implementation and may be performed by a greater number or fewer number of servers. One or more servers may be operated and/or maintained by the same or different entities.

The embodiment of the networked system 500 includes a plurality of customer devices 502 and a plurality of financial transaction systems 504. The customer devices 502 may be a user computing device discussed above in FIG. 1 and may be operated by the customers such as, for example, user 104. The financial transaction servers 504 may be housed at or shared among one or more financial institutions discussed above.

The customer devices 502 and financial transaction servers 504 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 500, and/or accessible over the network 102.

The network 102 may be implemented as a single network or a combination of multiple networks. For example, in various embodiments, the network 102 may include the

Internet and/or one or more intranets, landline networks, wireless networks, and/or other appropriate types of networks.

The customer devices 502 may be implemented using any appropriate combination of hardware and/or software configured for wired and/or wireless communication over network 102. For example, in one embodiment, the customer devices 502 may be implemented as a personal computer of a user in communication with the Internet. In other embodiments, the customer devices 502 may be a smart phone, wearable computing device, laptop computer, and/or other types of computing devices.

The customer devices 502 may include one or more browser applications which may be used, for example, to provide a convenient interface to permit the customer to browse information available over the network 102. For example, in one embodiment, the browser application may be implemented as a web browser configured to view information available over the Internet.

The customer devices 502 may also include one or more toolbar applications which may be used, for example, to provide user-side processing for performing desired tasks in response to operations selected by the customer. In one embodiment, the toolbar application may display a user interface in connection with the browser application.

The customer devices 502 may further include other applications as may be desired in particular embodiments to provide desired features to the customer devices 502. In particular, the other applications may include a client-side account management software that allows customer device 502 to interface with one or more financial transaction servers 504 to allow a user to manage one or more accounts. The other applications may also include security applications for implementing user-side security features, programmatic user applications for interfacing with appropriate application programming interfaces (APIs) over the network 102, or other types of applications. Email and/or text applications may also be included, which allow customer payer to send and receive emails and/or text messages through the network 102. The customer devices 502 include one or more user and/or device identifiers which may be implemented, for example, as operating system registry entries, cookies associated with the browser application, identifiers associated with hardware of the customer devices 502, or other appropriate identifiers, such as a phone number. In one embodiment, the user identifier may be used by the financial transaction servers 504 to associate the user with a particular account as described herein.

The financial transaction servers 504 may be maintained, for example, by a conventional or on-line financial institution or entity providing financial services. In this regard, the financial transaction servers 504 may include one or more databases for storing and managing user accounts and money cache accounts. The servers 504 also may include server-side application to facilitate remote management of user accounts over network 102.

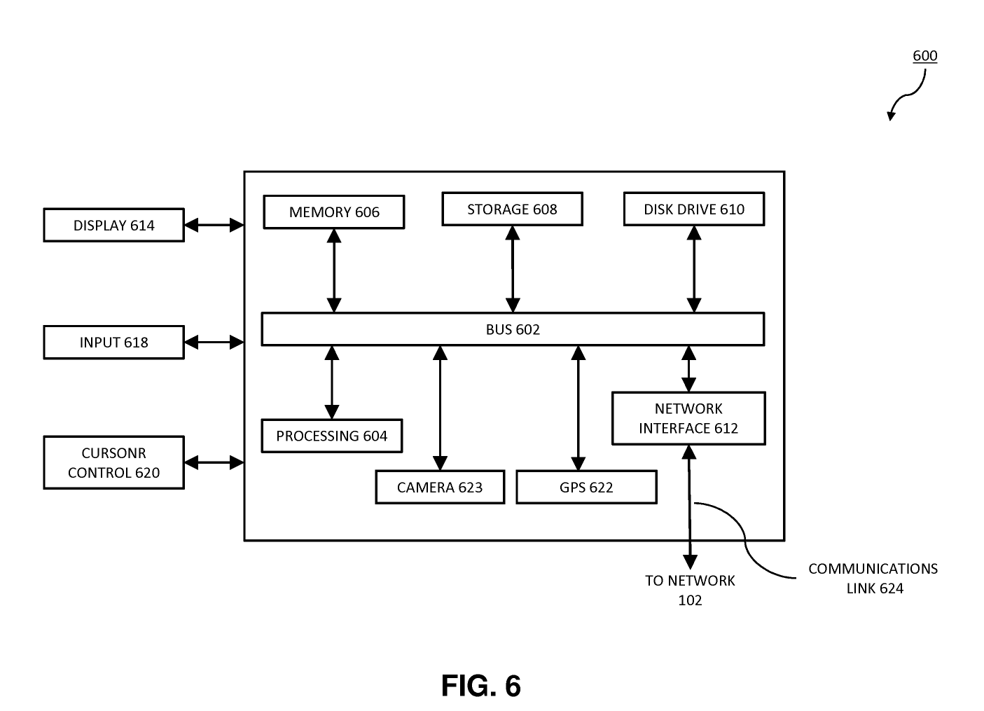

Referring now to FIG. 6, an embodiment of a computer system 600 suitable for implementing, for example, the financial transaction systems 114, 124, 134, and 140, or any other computing device required by the embodiments. It should be appreciated that other devices utilizing the financial transaction systems 114, 124, 134, and 140 in the system discussed above may be implemented as the computer system 600 in a manner as follows.

In accordance with various embodiments of the present disclosure, computer system 600, such as a computer and/or a network server, includes a bus 602 or other communication mechanism for communicating information, which interconnects subsystems and components, such as a processing component 604 (e.g., processor, micro-controller, digital signal processor (DSP), etc.), a system memory component 606 (e.g., RAM), a static storage component 608 (e.g., ROM), a disk drive component 610 (e.g., magnetic or optical), a network interface component 612 (e.g., modem or Ethernet card), a display component 614 (e.g., CRT or LCD), an input component 618 (e.g., keyboard, keypad, or virtual keyboard), a cursor control component 620 (e.g., mouse, pointer, or trackball), a location determination component 622 (e.g., a Global Positioning System (GPS) device as illustrated, a cell tower triangulation device, and/or a variety of other location determination devices known in the art), and/or a camera component 623. In one implementation, the disk drive component 610 may comprise a database having one or more disk drive components.

In accordance with the embodiments of the present disclosure, the computer system 600 performs specific operations by the processor 604 executing one or more sequences of instructions contained in the memory component 606, such as described herein with respect to the financial transaction systems 114, 124, 134, 140, and 304. Such instructions may be read into the system memory component 606 from another computer readable medium, such as the static storage component 608 or the disk drive component 610. In other embodiments, hard-wired circuitry may be used in place of or in combination with software instructions to implement the present disclosure.

Logic may be encoded in a computer readable medium, which may refer to any medium that participates in providing instructions to the processor 604 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 610, volatile media includes dynamic memory, such as the system memory component 606, and transmission media includes coaxial cables, copper wire, and fiber optics, including wires that comprise the bus 602. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes,

RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 600. In various other embodiments of the present disclosure, a plurality of the computer systems 600 coupled by a communication link 624 to the network 102 (e.g., such as a LAN, WLAN, PTSN, and/or various other wired or wireless networks, including telecommunications, mobile, and cellular phone networks) may perform instruction sequences to practice the present disclosure in coordination with one another.

The computer system 600 may transmit and receive messages, data, information and instructions, including one or more programs (i.e., application code) through the communication link 624 and the network interface component 612. The network interface component 612 may include an antenna, either separate or integrated, to enable transmission and reception via the communication link 624. Received program code may be executed by processor 604 as received and/or stored in disk drive component 610 or some other non-volatile storage component for execution.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. An electronic transaction computer system for accelerating the availability of funds involved in an international money transfers, comprising:
at least one network interface placing the computer system in communication with a money transfer network, the money transfer network providing digital communication between the computer system and a plurality of financial institutions;
a database that stores information related to a plurality of user accounts and a money cache account, wherein the money cache account is associated with one or more of the plurality of user accounts;
a non-transitory memory unit for storing a plurality of software instructions; and
at least one computer processor that executes the plurality of software instructions that causes the system to perform operations comprising:
receive a first message from one of the plurality of financial institutions through the money transfer network, the first message indicating a monetary amount that is to be transferred and the user account to which the amount is to be transferred to;
determine whether the user account is associated with the money cache account; and
when the user account is associated with the money cache account:
transfer at least a portion of the indicated monetary amount from the money cache account to the user account;
receive a second message from the one of the plurality of financial institutions through the money transfer network, the second message including the monetary amount to be transferred to the user account; and
transfer at least a portion of the monetary amount to the money cache account.

2. The computer system of claim 1, wherein the instructions that transfer at least a portion of the indicated monetary amount from the money cache account to the user account transfers the indicated monetary amount minus a transaction fee, and wherein the instructions that transfer at least a portion of the monetary amount to the money cache account transfers the entire portion of the monetary amount to the money cache.

3. The computer system of claim 2, wherein the money cache account is funded at least in part based on the transaction fee.

4. The computer system of claim 1, wherein the computer system is located in one country and the first and second messages are transmitted by a financial institution located in another country.

5. The computer system of claim 1, wherein the computer system is associated with a particular financial institution and the first and second messages are transmitted by another financial institution.

6. The computer system of claim 1, wherein the money cache account's association with at least one user account is based on a score that adjusts based on whether at least a portion of the monetary amount is transferred into the money cache account.

7. The computer system of claims 6, wherein the instructions for determining whether the user account is associated with the money cache account includes instructions for determining whether the score associated with the user account meets a threshold score, the threshold score being the minimum score required to allow the user account to utilize the money cache account.

8. The computer system of claim 6, wherein the score is based on at least one of the user account's previous usage of the money cache account, the funds currently available in the user account, the user account participation in funding the money cache account, or a credit score of a user associated with the user account.

9. The computer system of claim 1, wherein the money cache account is funded at least in part by contributions from the user accounts associated with the money cache account.

10. The computer system of claim 1, wherein the instructions for determining whether the user account is associated with the money cache account includes instructions for checking preferences of the user account and returning a positive determination if the preferences indicate an interest in using the money cache account.

11. The computer system of claim 10, wherein the preferences indicate at least one of a minimum or maximum transfer amount required in order to use the money cache account, a list of incoming sources for which the money cache account is to be used, or a designation of whether the money cache account is to be used for transfers occurring with a particular frequency.

12. A computer-implemented method for accelerating the availability of a monetary amount in the process of being transferred from a first user account at a first financial institution to a second user account at a second financial institution, comprising:
receiving, by a computer processor, a first message from the first financial institution, the first message indicating an intent to transfer a monetary amount from the first user account to the second user account;
determining, by a computer processor, whether the second user account is associated with a money cache account; and
when the second user account is associated with the money cache account:
transferring, by a computer processor, at least a portion of the monetary amount indicated in the first message from the money cache account to the second user account;
receiving, by a computer processor, a second message from the first financial institution, the second message including at least the monetary amount; and
processing, by a computer processor, the second message by transferring at least a portion of the monetary amount included in the second message to the money cache account.

13. The computer-implemented method of claim 12, further comprising:
funding a money cache account, wherein the money cache account is funded, at least in part, by finds provided by a plurality of user accounts at the second financial institution;

14. The computer-implemented method of claim 12, wherein the first message is sent to verify whether the second user account is at the second financial institution.

15. The computer-implemented method of claim 12, wherein determining whether the second user account is associated with a money cache account is determined based on a score associated with the second user account.

16. The computer-implemented method of claim 15, wherein the score is based on previous usage of the money cache account.

17. The computer-implemented method of claim 15, wherein the score is based on a credit score provided by a credit scoring service.

18. The computer-implemented method of claim 15, wherein the score is adjusted based on whether funds included in the second message are transferred into the money cache account.

19. The computer-implemented method of claim 15, wherein the score is increased each time the monetary amount included in the second message is transferred into the money cache account.

20. The computer-implemented method of claim 12, further comprising:
determining a monetary amount to be transferred from the money cache account to the second user account, wherein the determination is based on a score associated with the user account.

21. An electronic transaction computer system for accelerating the availability of a monetary amount that is in the process of being transferred to a user account at a financial institution:
a computer processor; and
a non-transitory memory unit for storing a message processor and an account manager, the message processor and the account manager including instructions executed by the computer processor;
wherein the message processor is configured to receive a first message and a second message, the first message indicating an intent to transfer a monetary amount to the user account and the second message including at least the monetary amount; and
wherein the account manager is configured to:
upon receiving the first message, transfer at least a portion of the monetary amount indicated in the first message from a money cache account to the user account; and
upon receiving the second message, transfer at least a portion of the monetary amount included in the second message to the money cache account.

22. The electronic financial transaction computer system of claim 21, wherein the account manager is further configured to only transfer the monetary amount from the money cache to the user account if account manager determines that the user account is associated with the money cache account.

23. The electronic financial transaction computer system of claim 21, wherein the portion of the monetary amount transferred from the money cache account to the user account is based on a user account score, wherein the user account score is based on prior transfers involving the user account, the money cache account, and the second message.
